(19) United States
(12) Patent Application Publication
(10) Pub. No.: US 2009/0202165 A1
(43) Pub. Date: Aug. 13, 2009

(54) IMAGE DECODING METHOD AND IMAGE DECODING APPARATUS

(75) Inventor: Sunao Tabata, Mishima-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Minato-ku (JP); TOSHIBA TEC KABUSHIKI KAISHA, Shinagawa-ku (JP)

(21) Appl. No.: 12/030,351

(22) Filed: Feb. 13, 2008

(51) Int. Cl. G06T 9/00

(52) U.S. Cl. 382/248

(57) ABSTRACT

According to an embodiment of the invention, a high-speed and high-image-quality image decoding method and apparatus for a compressed signal including plural components or a block code in which different compression systems are combined. In an image decoding method in which compressed data of an image signal including plural components including a resolution component expressed by the n-th power of 2 (where n is an integer equal to or greater than 0) and processed by a frequency conversion system is decoded by inverse frequency conversion of each component, a resolution component of each compressed data for each component is individually set and decoded when decoding resolution at the time of decoding is lower than the highest resolution of the compressed data.

### BACKGROUND OF THE INVENTION

### 1. Field of the Invention

The present invention relates to an image decoding method and an image decoding apparatus in which the balance between deterioration in image quality and decoding speed is improved.

Since image data has a large data volume, it is common to compress image data when transmitting or storing the image data. As an exemplary application of an image, low-frequency components of an image are often used such as thumbnail information of the image, instead of using the information of the entire image having a large data volume. However, the processing takes time if the entire image information is decoded every time a thumbnail image is generated. To deal with this problem, the following techniques are proposed.

### Patent Reference 1: JP-A-7-222151

### Patent Reference 2: JP-A-2005-136873

The technique disclosed in Patent Reference 1 is a system in which coded data with a required frequency is taken out and decoded from a code compressed by a frequency conversion system, in accordance with a required reduction ratio. Particularly a JPEG technique using DCT is disclosed in its embodiment.

The technique disclosed in Patent Reference 2 is, again, a system in which coded data with a required frequency is taken out and decoded from a code compressed by a frequency conversions system, in accordance with a required reduction A JPG 2000 technique using a wavelet is disclosed.

Meanwhile, for image compression, not only the frequency conversion system but a block code configuration may be considered in which image data is compressed by a combination of different compression systems between blocks.

However, in the methods disclosed in Patent References 1 and 2, though the description about one component is given, handling of plural components such as YCbCr used in color images is not referred to.

### BRIEF SUMMARY OF THE INVENTION

Thus, it is an object of the invention to provide a high-speed, high-image-quality image decoding method and apparatus for a compressed signal including plural components and a block code with a combination of different compression systems.

To achieve the above object, according to an aspect of the invention, in an image decoding method, compressed data of an image signal which includes plural components including a resolution components expressed by the n-th power of 2 (where n is an integer equal to or greater than 0) and processed by a frequency conversion system is decoded by inverse frequency conversion of each component. The method is characterized in that when decoding resolution at the time of decoding is lower than the highest resolution of the compressed data, the resolution component of each compressed data for each component is individually selected and decoded.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1A is a schematic explanatory view of an image compressing and decoding apparatus to which the invention is applied, and FIG. 1B is a view of configuration of an operation flow for explaining the operation of a first embodiment of this invention.

FIG. 2 is a view of configuration of an operation flow for explaining decoding processing of a compressed image signal compressed by a JPEG system.

FIG. 3A to FIG. 3D are explanatory views of patterns of component combinations in a minimum code unit used in JPEG.

FIG. 4 is an explanatory view for explaining an example of decoding the MCU of FIG. 3D.

FIG. 5 is an explanatory view of inverse DCT calculation formulas (1) and (2).

FIG. 6 is an explanatory view of an inverse DCT calculation formula (3) for reduction decoding.

FIG. 7 is an explanatory view for explaining an example of taking out a DCT coefficient for reduction.

FIG. 8 is an explanatory view for explaining an example in which a decoding DCT coefficient for each component is set in processing block S1-2 of FIG. 1.

FIG. 9 is an explanatory view for explaining an example in which a reduction decoding operation is carried out.

FIG. 10A and FIG. 10B are explanatory views for explaining another example in which a reduction decoding operation is carried out.

FIG. 11 is a view of configuration of an operation flow for explaining a first modification of the first embodiment.

FIG. 12 is a view for explaining an example of setting a decoding DCT coefficient for each component of the first modification in processing block S1-2 of FIG. 1.

FIG. 13 is a view of configuration of an operation flow for explaining the operation of a second embodiment.

FIG. 14 is an explanatory view showing the relation between an image and a compressed block as an example of a code with a mixture of a frequency code and a non-frequency code in the second embodiment.

FIG. 15 is a view showing processing block S2-2 in FIG. 13, and an example of setting a decoding DCT coefficient and a reduction ratio for each frequency code and non-frequency code in the second embodiment.

FIG. 16 is an explanatory view for explaining a reduction decoding operation of a DCT plus run-length code.

### DETAILED DESCRIPTION OF THE INVENTION

Hereinafter, embodiments of the present invention will be explained in detail with reference to the attached drawings.

Hereinafter, embodiments of the present invention will be explained further in detail with reference to the drawings.

### Embodiment 1

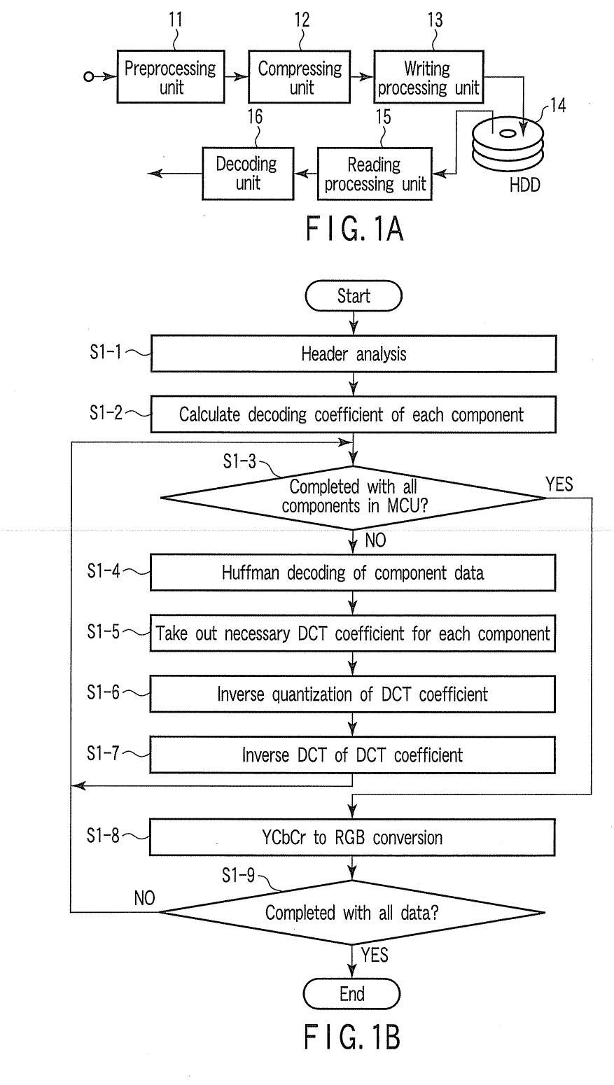

FIG. 1A shows, in the form of a block configuration, an outline of a recording and reproducing apparatus to which the invention is applied. For example, an input image signal from a scanner is inputted to a preprocessing unit 11. R, G and B signals are converted to, for example, YCbCr signals. Each of the YCbCr signals is inputted to a compressing unit 12 and converted to compressed signal as described below. The output signal of the compressing unit 12 is converted to a writing format by a writing processing unit 13 and is written to, for example, a hard disk 14.

The signal read out of the hard disk 14 is demodulated by a reading processing unit 15. The demodulated signal is inputted to a decoding unit 16 and decoded as described hereinafter.

FIG. 1B is a flowchart for explaining a characteristic functional block of the invention that operates in the decoding unit 16.

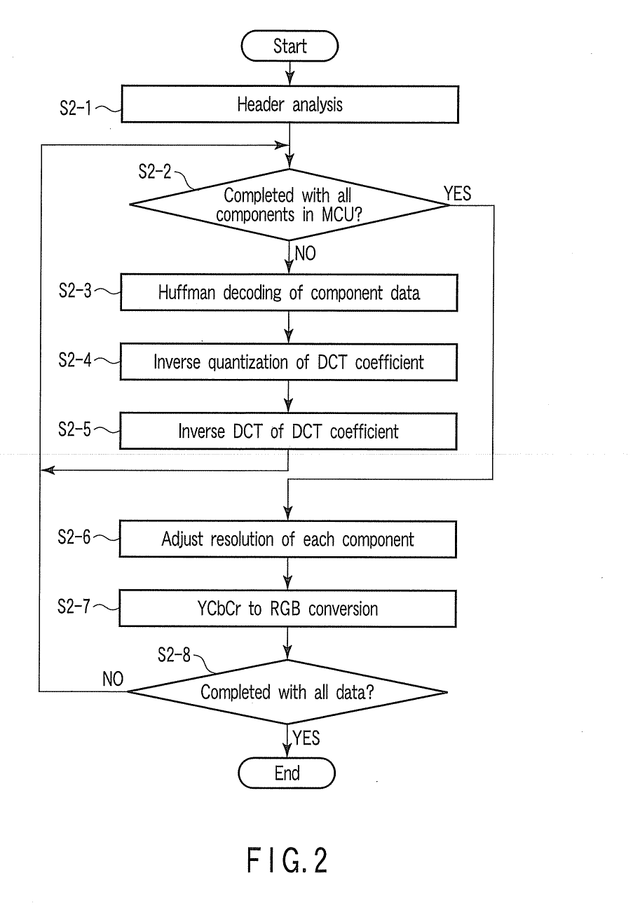

First, to make the function of the invention easier to understand, the basic operation of JPEG decoding processing will be described with reference to FIG. 2.

Since both JPEG compression processing and decoding processing have been known, decoding processing related to the invention will be described with reference to FIG. 2.

First, a header analyzing unit (step S2-1) acquires necessary information for decoding such as the number constituting compressed data, the number of blocks of each component constituting a compression unit MCU (minimum code unit), and the quantization table.

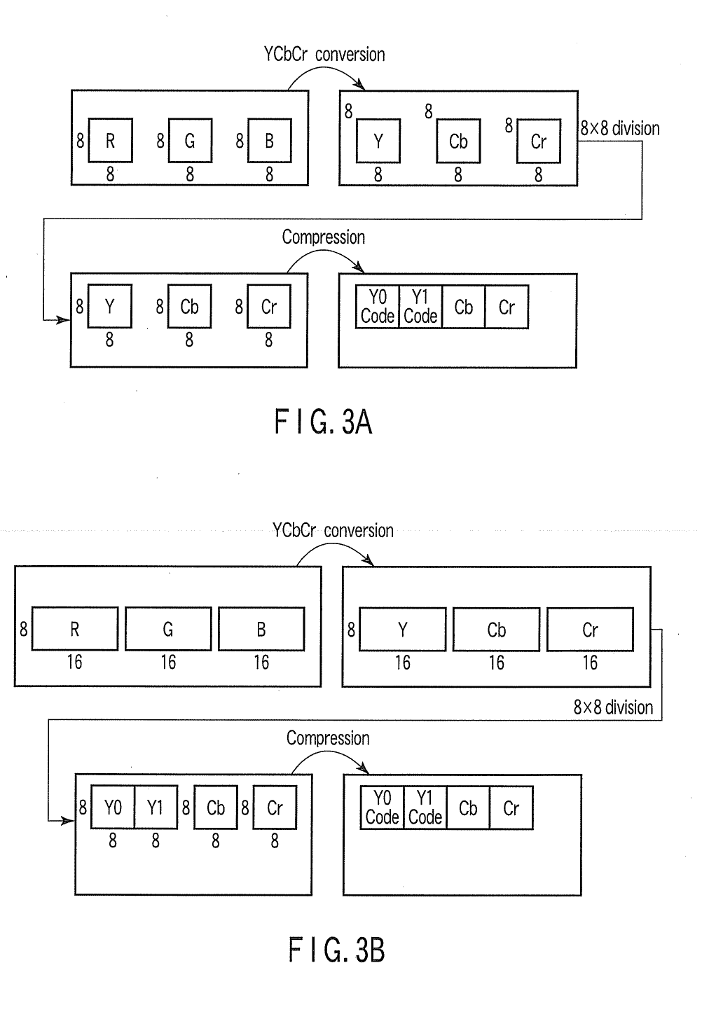

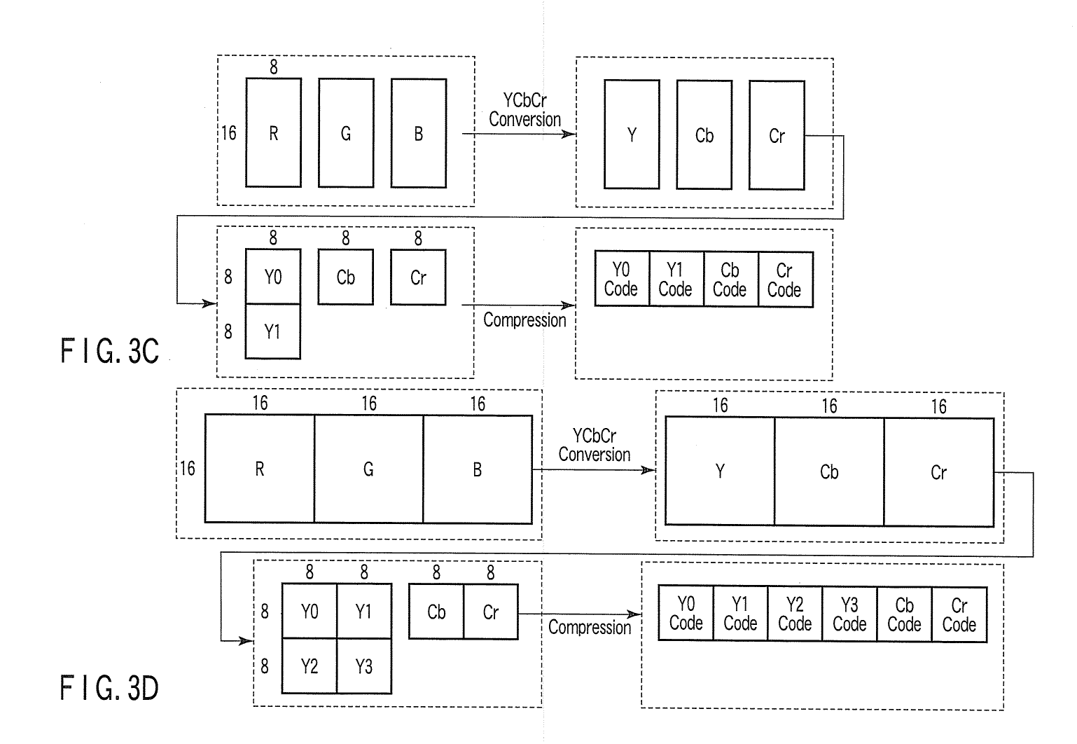

As an MCU, 8×8 pixels are considered to be one compression unit according to JPEG, as shown in FIG. 3A and FIG. 3D. However, YCbCr conversion is performed on RGB signals to compress the signal with its luminance and color difference varied.

R represents a red component signal. G represents a green component signal. B represents a blue component signal. Y represents a luminance component signal. Cb represents a blue color-difference signal. Cr represents a red color-difference signal.

From the above header analysis, at least the number of components included in the compressed data, the resolution of each component (compressed data) and the like can be learned.

Resolution patterns of luminance and color difference at the time of YCbCr conversion include patterns as shown in FIG. 3 A to FIG. 3D. FIG. 3A shows a pattern in which resolution is always the same. That is, the resolution of 8×8 pixels is employed in each of the RGB stage and the YCbCr stage. FIG. 3B shows a pattern in which main scanning resolution is halved for color difference. That is, in the RGB stage, resolution is 8×16 pixels each, and in the YCrCb stage, resolution is 8×16 pixels for Y and 8×8 pixels for Cb and Cr. FIG. 3C shows a pattern in which sub scanning resolution is halved for color difference. That is, in the RGB stage, resolution is 16×8 pixels each, and in the YCrCb stage, resolution is 16×8 pixels for Y and 8×8 pixels for Cb and Cr. FIG. 3D shows a pattern in which main and sub scanning resolutions are halved for color difference. That is, in the RGB stage, resolution is 16×16 pixels each, and in the YCrCb stage, resolution is 16×16 pixels for Y and 8×8 pixels for Cb and Cr.

Hereinafter, the description will be made with respect to the CbCr main and sub scanning ½ pattern of FIG. 3D as an explanatory example. The description will be made with reference to FIG. 2 again.

In step S2-2, it is checked whether processing of all blocks constituting an MCU (in this example, six blocks of Y0+Y1+Y2+Y3+Cb+Cr) has been completed or not. The processing of steps S2-3, S2-4 and S2-5 is carried out for each block until processing of all the blocks constituting the MCU has been completed.

In step S2-3, coded data is Huffman-decoded to calculate a quantized DCT coefficient. In step S2-4, inverse quantization processing is carried out on the quantized DCT coefficient to calculate a DCT coefficient. In the case where coding is done by taking the difference of DC components between blocks, the preceding block DC component is added with respect to the DC component.

In step S2-5, processing to convert the DCT coefficient to an inverse DCT coefficient is carried out to convert it to an image signal value.

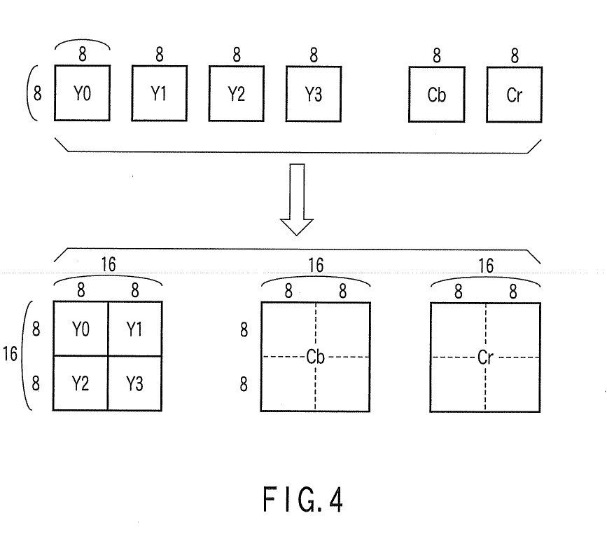

When decoding of each component in the MCU to an image signal has been completed, resolution is equalized in step S2-6. Specifically, as for Y, four Y components are arrayed in a 16×16-pixel unit, and for Cb and Cr, a 16×16 image is created by double enlargement in the main and sub scanning directions, as shown in FIG. 4.

In step S2-7, the YCbCr signals are converted to RGB signal. In step S2-8, it is checked whether all the data to be decoded have finished or not. If not finished, the processing of each MCU is repeated. When decoding of all the data has been finished, the processing ends.

Next, an example of performing reduction decoding of a signal of one component (gray) to ½ resolution at a high speed will be described.

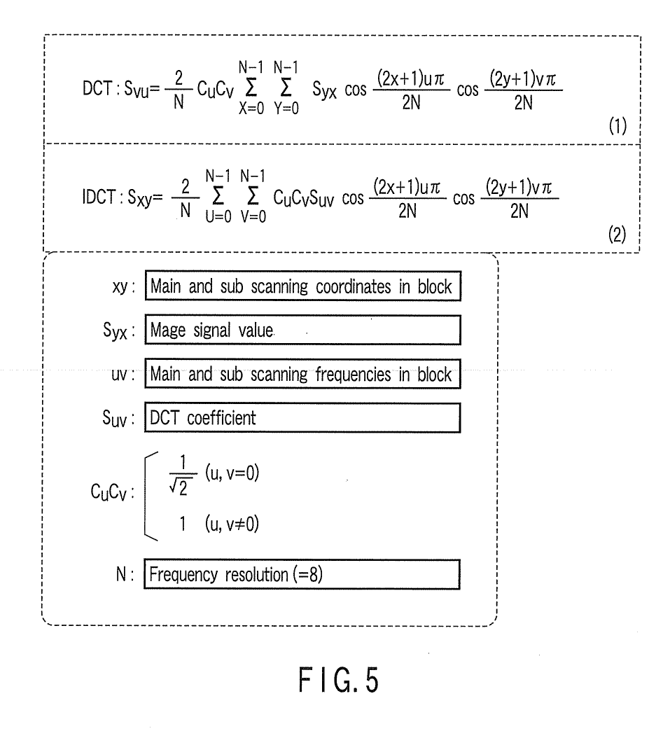

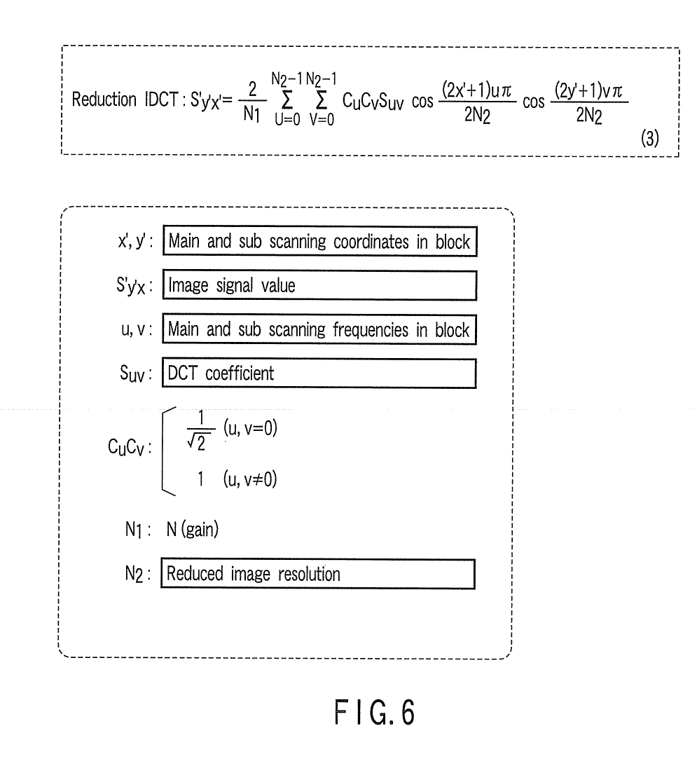

DCT conversion and inverse DCT conversion are calculated in accordance with the relations expressed by equations (1) and (2) in FIG. 5. To acquire a reduced image, a resolution level can be set in accordance with the reduction ratio, as expressed by equation (3) in FIG. 6.

That is, if decoding is to be carried out with ½ resolution where N is 8, N2 of equation (3) is N2=(½)×N, that is, N2=4. It suffices to do the calculation only in the case where the decoding pixel values x′ and y′ are 0 to 3, and the frequency components u and v are 0 to 3.

That is, the quantity of arithmetic operation to decode a reduced image is (¼)×(¼)= 1/16 if the quantity of arithmetic operation to decode the entire image is 1.

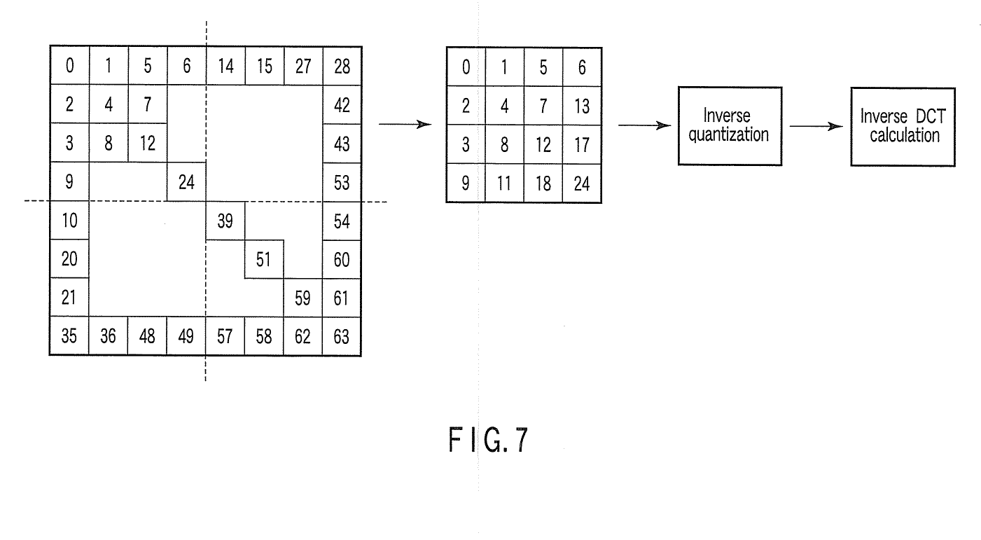

In the case of 64 DCT coefficients as shown in FIG. 7 that have been Huffman-decoded in step S2-3, 16 target frequency components (0, 1, 2, 3, 4, 5, 6, 7, 8, 9, 11, 12, 13, 17, 18, 24) are taken out. Then, inverse quantization is carried out in step S2-4 and inverse DCT is calculated in step S2-5.

FIG. 1B shows an example of decoding a reduced image that includes plural components according to the invention. That is, calculation of a decoding target coefficient for each component is carried out in step S1-2. Also, a necessary DCT coefficient is taken out for each component in step S1-5 (DCT coefficient takeout block).

The processing steps of FIG. 1B and FIG. 2 correspond to each other as follows.

Step S1-1 is the processing similar to step S2-1 (header analysis block) of FIG. 2.

Step S1-3 is the processing similar to step S2-2 (all-component processing confirmation block) of FIG. 2.

Step S1-4 is the processing similar to step S2-3 (Huffman decoding block) of FIG. 2.

Step S1-6 is the processing similar to step S2-4 (inverse quantization block) of FIG. 2.

Step S1-7 is the processing similar to step S2-5 (inverse DCT block) of FIG. 2.

Step S1-8 is the processing similar to step S2-7 (conversion block) of FIG. 2.

Step S1-9 is the processing similar to step S2-8 (processing completion confirmation block) of FIG. 2.

In FIG. 1B, step S2-6 (FIG. 2) to equalize the resolution of each component is eliminated. Moreover, step S1-6 of inverse quantization processing, step S1-7 of inverse DCT calculation processing, and the quantity of arithmetic operation for conversion from YCbCr to RGB are changed in accordance with the reduction ratio.

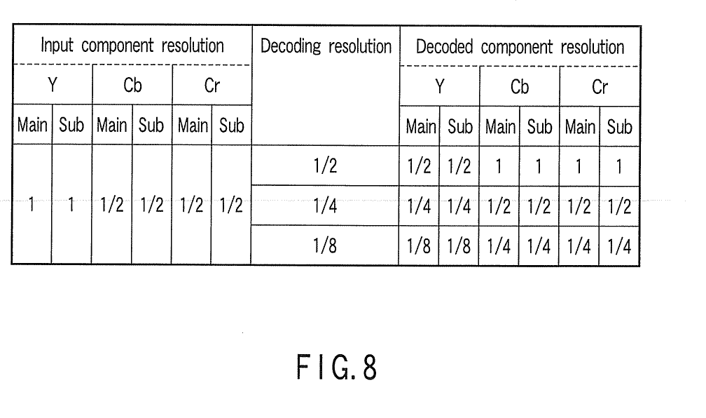

In the calculation of the coefficient according to the reduction ratio, the resolution and reduction ratio of the component are used for the calculation as shown in FIG. 8. In the case where the resolution of Cb and Cr is ½ each with respect to Y of compressed data, calculation with resolution that is twice the decoding resolution of Y is carried out for Cb and Cr.

Thus, pixels equivalent to those in the case of acquiring a reduced image from a normal decoding result can be provided. FIG. 8 shows cases where the decoding resolution of Y is ½, ¼, and ⅛. For Cr and Cb, calculation processing is carried out with resolution that is twice the decoding resolution of Y.

As a matter of course, also when the patterns of FIG. 3A to FIG. 3C are used, coefficient values of decoding targets are calculated as in the above description. For example, in the case of FIG. 3A, the calculation is equivalent to the case of applying a conventional method to all of YCbCr. If resolution differs only in main scanning or sub scanning of a certain component, the rule similar to the above may be applied to that component.

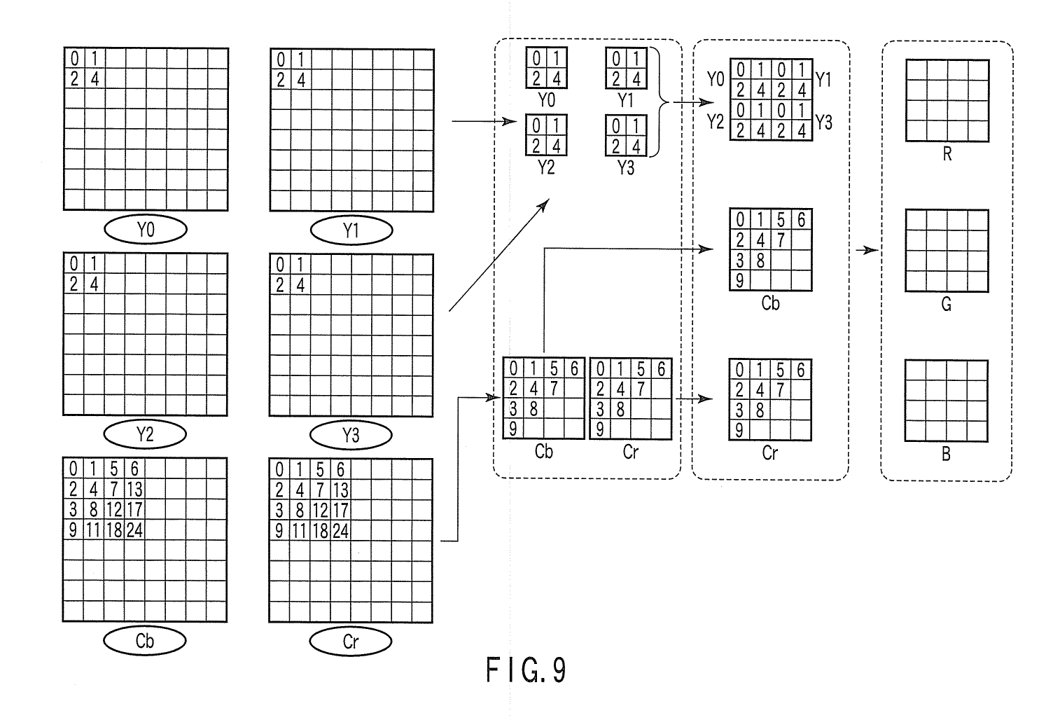

As a specific range of setting a decoding coefficient, if the decoding resolution ¼ of FIG. 8 is applied in the example of FIG. 9, since one MCU in the pattern of FIG. 3D includes four Y components (Y0, Y1, Y2 and Y3) and one Cb and Cr each, four coefficients for Y (parts filled with numbers) and 16 coefficients for Cb and Cr are taken out in step S1-5. The coefficients that have been taken out are inversely quantized in steps S1-6 and S1-7, and inverse DCT is calculated to provide decoded YCbCr values. For Y, four blocks are integrated into a 4×4 size and converted to RGB in step S1-8. Since the compressed data has a size of 16×16 in the MCU stage, a decoded image of the 4×4 size can be provided, which is ¼ of the former size.

In short, when the decoding resolution with which compressed data is to be decoded is lower than the highest resolution of the compressed data, the resolution component of each compressed data of each component is individually set and decoded.

Also, while the reduction ratio is set at ½ n in this example, a configuration can be employed in which an intermediate reduction ratio is set so that a decoding DCT coefficient range can be combined with reduction and enlargement processing in accordance with the ratio, as in Patent Reference 1.

That is, when decoding resolution is higher than the lowest resolution of compressed data as a decoding target and is lower than the highest resolution of the compressed data, a component having resolution that is closest the decoding resolution (a resolution component equal to or higher than the decoding resolution) is selected as a lowest-resolution component of the compressed data. Also, the lowest resolution of each component of the compressed data in this case is made equal or different.

Thus, since a resolution component of decoded data is selected in accordance with the resolution balance of the components of the compressed data, the balance between image quality and decoding speed is improved.

Also, in the case where the reduction ratio is less than ⅛, the reduction can be realized by decoding of only the DC (that is, one coefficient) and subsequent reduction processing. That is, when the decoding resolution is lower than the lowest resolution of compressed data as a decoding target, the lowest-resolution component of this compressed data (for example, n=0) is selected and set.

Thus, when the decoding resolution is lower than the lowest-resolution component of the compressed data, only the lowest-resolution component is used for decoding and therefore the decoding speed improves.

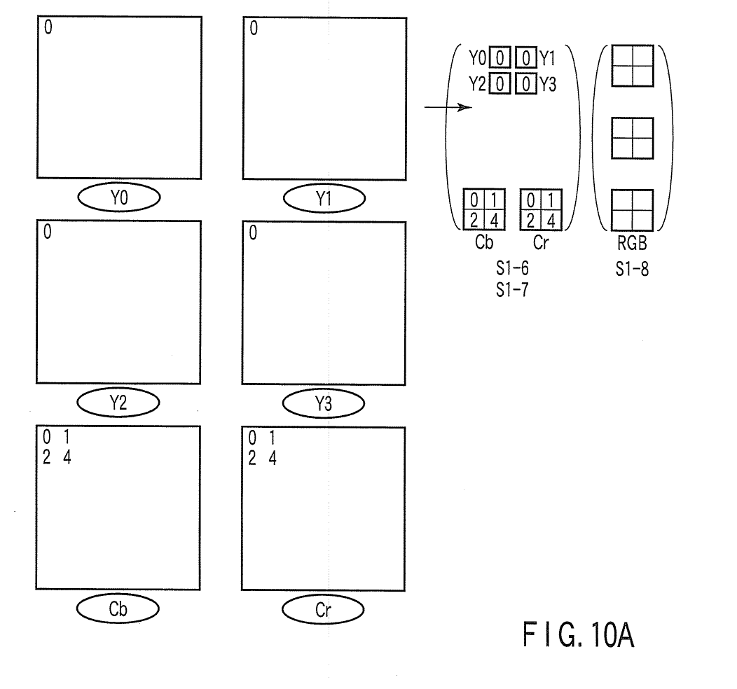

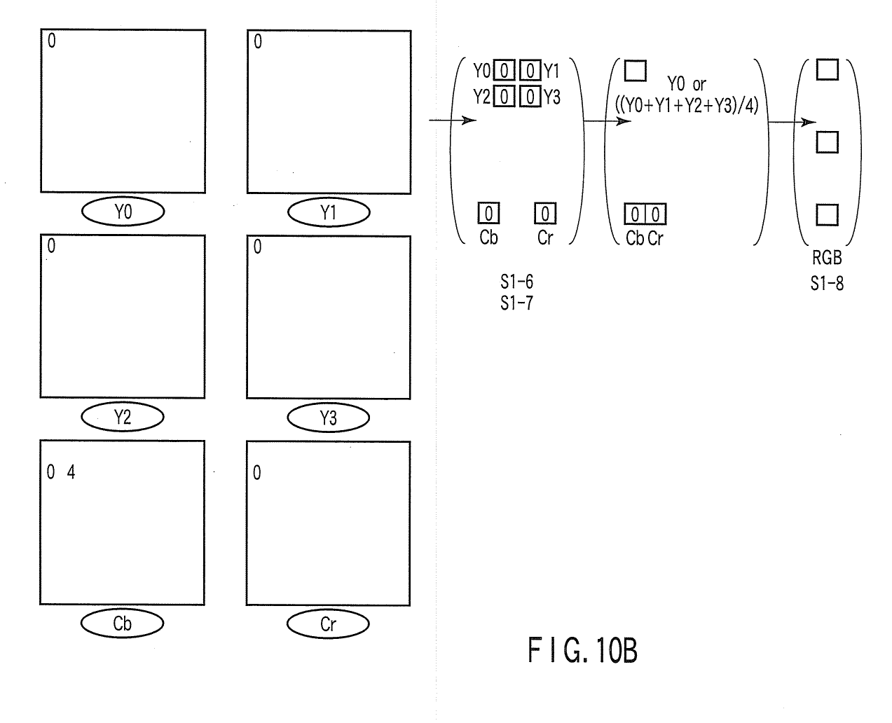

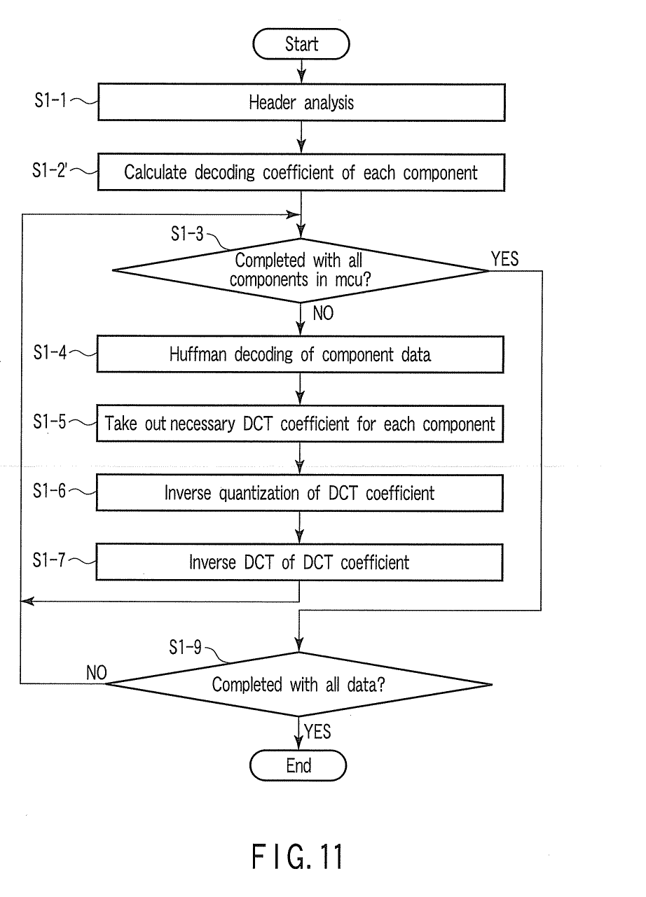

Meanwhile, for example, in the case of the pattern of FIG. 3D, ⅛ reduction can be realized by decoding of only the DC (DC component) for Y and decoding of four coefficients for Cb and Cr, and 1/16 reduction can be realized by decoding and reduction of only the DC for Y and decoding of only the DC for Cb and Cr, as shown in FIG. 10A and FIG. 10B. Reduction to a size less than 1/16 can be realized by re-reduction of the result of 1/16 reduction.

Also, the take-out of only the DC is univocally decided in accordance with the coefficient value, as can be seen from equation (3), and therefore may be taken out from a table instead of calculation.

In this example, to realize image quality similar to the image quality the case of reduction from a decoded image, a decoding coefficient is selected in accordance with the resolution of a component. However, to raise the speed of processing, it is possible to employ a configuration in which the same coefficient selection range is used irrespective of resolution (for example, in the example of FIG. 9, four coefficients for Cb and Cr similarly to Y, instead of 16), and enlargement or the like is combined. Also, in the case where the compressed component resolution of YCrCb is equal, it is possible to employ a configuration in which reduction decoding is carried out for Cb and Cr and enlargement is carried out before RGB conversion.

Moreover, while the general DCT calculation formulas are used for the description of this example, it is obvious that calculations can be reduced by the same idea in high-speed DCT as well.

While JPEG is employed as an exemplar in this example, the compression system is not limited to this example and the decoding procedures are not limited to this example, either.

As described above, a block code using a frequency conversion system including plural components can be decoded at a high speed and with high image quality by selecting a decoding coefficient for each component in accordance with the reduction ratio at which the code is to be decoded.

### First Modification of First Embodiment

FIG. 11 shows a modification of the first embodiment and is similar to FIG. 1 except that data to be handled is changed from RGB to CMYK, that the calculation of a decoding coefficient for each component is changed to S1-2′, and that S1-8 of conversion from YCbCr to RGB is eliminated.

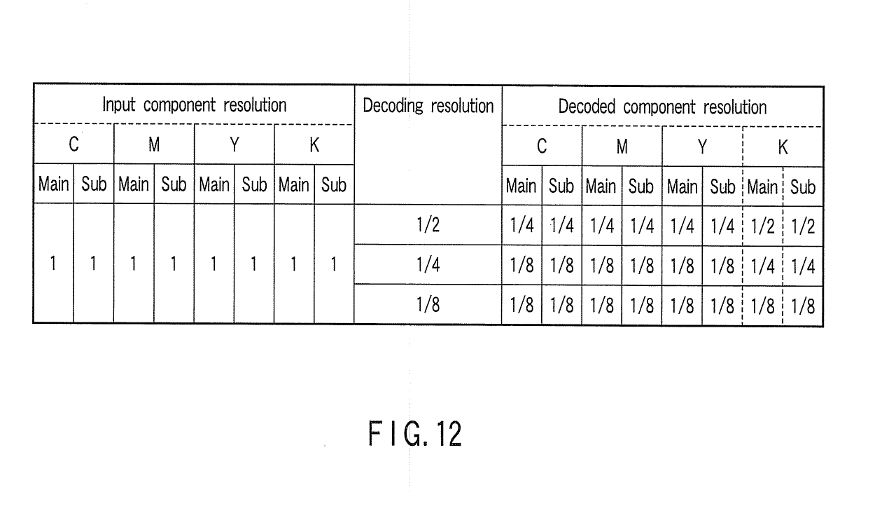

In S1-2′, in the case where the colors of CMYK of compressed data have the same resolution, a decoding coefficient only for K is selected in accordance with the decoding resolution while ½ of the decoding resolution is set for the other components of CMY and the like in which deterioration is less perceptible than in K, as shown in FIG. 12. Thus, processing with less perceptible deterioration in image quality and with high-speed reduction decoding can be realized.

FIG. 12 shows examples of resolution of each decoded component CMYK in the case where the resolution of input components CMYK is 1 for both main and sub and the decoding resolution is ½, ¼, and ⅛.

That is, this embodiment is an image decoding method in which a compressed image obtained by compressing image signals including CMYK signals by using a frequency conversion system having a resolution component expressed by the n-th power of 2 (where n is an integer equal to or greater than 0) is decoded by inverse frequency conversion for each color signal.

Then, (1) when the decoding resolution is lower than the highest resolution of the compressed data, a resolution component of the compressed data as a decoding target is selected for each color signal. (2) Meanwhile, when the decoding resolution is lower than the lowest resolution of the compressed data, the lowest-resolution component (n=0) of the compressed data is selected and decoded. When the decoding resolution is higher than the lowest resolution of the compressed data and lower than the highest resolution of the compressed data, at least for the K signal, a component that is closest to the decoding resolution (a resolution component equal to or higher than the decoding resolution) is selected and decoded.

Thus, since decoded data with its image quality emphasized is selected for the K signal, which is the most important of the CMYK signals, the balance between image quality and decoding speed is improved.

As a matter of course, in the case where the CMYK components have different resolution at the time of compression, for example, in the case of compressing the CMYK signals by converting CMY signals to YCbCr with Y of YCbCr being the same resolution as K and Cb and Cr being ½ resolution, a decoding coefficient can be selected in accordance with the resolution of each component, as in the first embodiment. Since the quantity of arithmetic operation can be reduced except for important information in terms of image quality, a reduced image with good image quality can be provided by high-speed processing.

### Second Embodiment

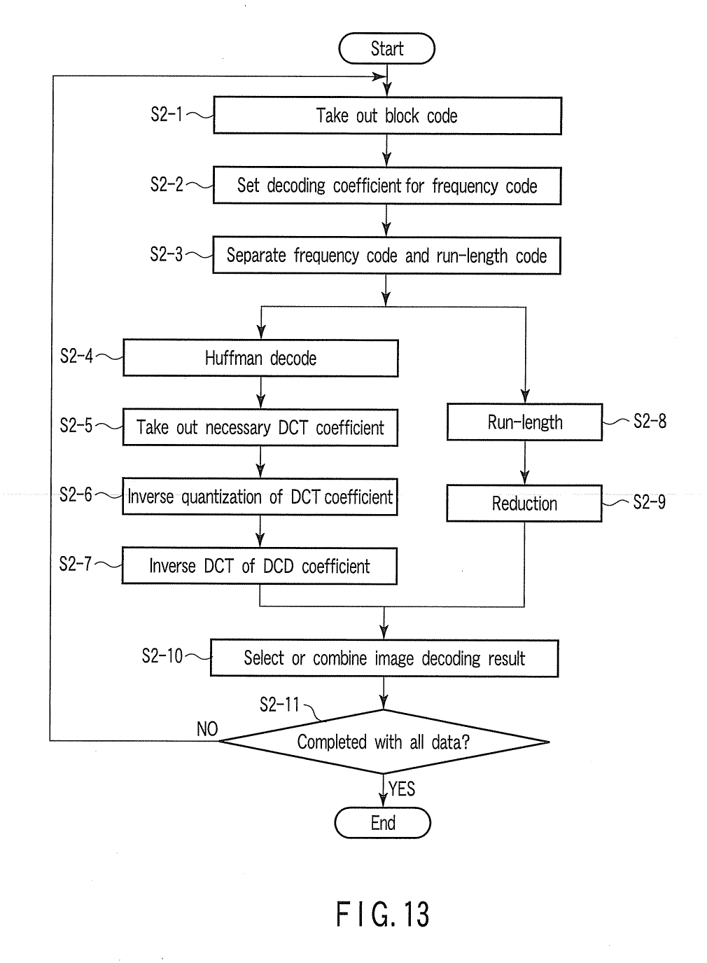

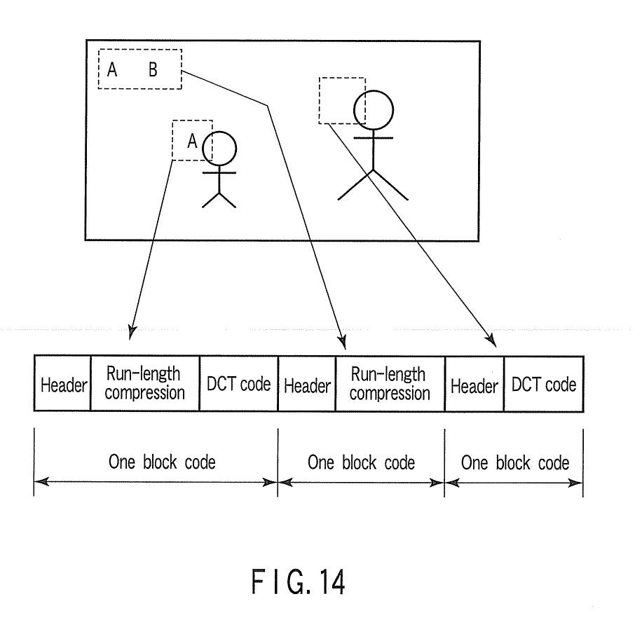

FIG. 13 is a view for explaining a second embodiment of the invention. Now, with respect to a block code of an 8×8 unit shown in FIG. 14, a code in which a frequency code (DCT as in JPEG) and a non-frequency code (run-length) are combined is subject to processing.

Whether a block code includes both a frequency code and a non-frequency code or includes only one of them can be determined by analysis of the header of each block. Now, in this code, a block containing only a line drawing such as a character is coded by run-length coding. A block containing only a photograph is coded by DCT coding. For a block in which both of these exist, a character part is coded by run-length coding and the other data than the character information is coded by DCT coding.

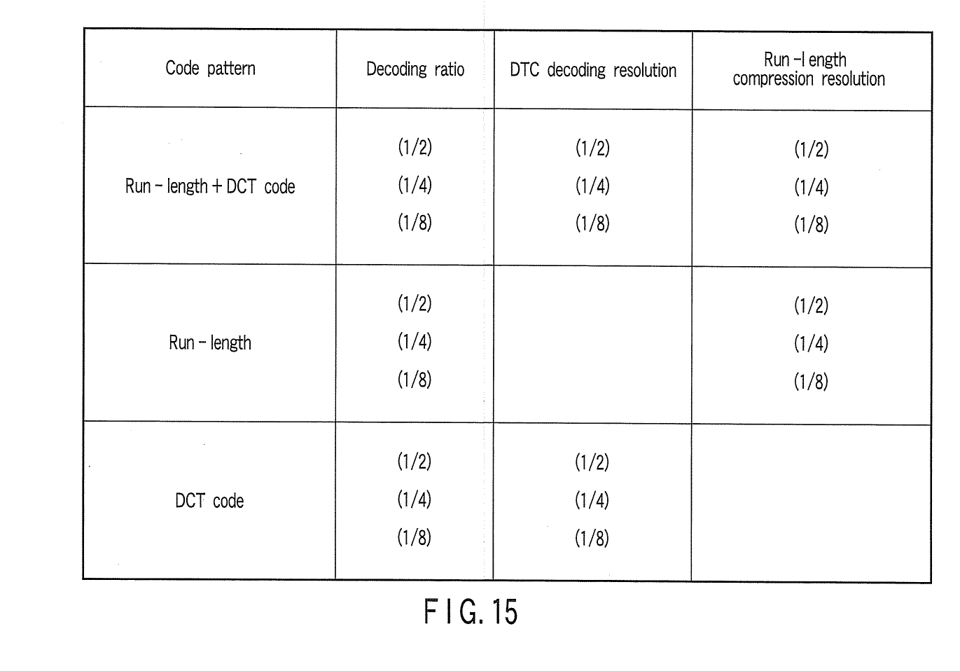

As the processing procedures, a code of a block unit is taken out in step S2-1, and a DCT decoding coefficient corresponding to the decoding ratio (step S2-5) and a run-length reduction ratio (step S2-9) as shown in FIG. 15 are set in step S2-2.

For a code constituted by a run-length code or singly by a DCT code, a reduction ratio corresponding to decoding resolution is set in the processing of each corresponding code. In the case of a block in which both exist, run-length or DCT is selected as a code to be decoded, in accordance with the ratio.

Even if both the frequency code system and the non-frequency code system exist, the decoding speed can be improved as the quantity of decoding calculation in the frequency code system is reduced. In this embodiment, with respect to a block code in which both the frequency conversion system and the non-frequency conversion system exist, a decoding resolution component of the frequency conversion system and compressed data of the non-frequency conversion system are arbitrarily selected and decoded.

Thus, since a decoding target can be selected with respect to compressed data in which codes of the frequency conversion system and the non-frequency conversion system are mixed or switched, the balance between image quality and decoding speed improves.

For a DCT code, Huffman decoding processing (step S2-4), take-out of a necessary DCT coefficient (step S2-5), inverse quantization of the DCT coefficient (step S2-6) and inverse DCT of the DCT coefficient (step S2-7) are carried out. For run-length, decoding is carried out (step S2-8) and reduction is carried out at a predetermined reduction ratio (step S2-9).

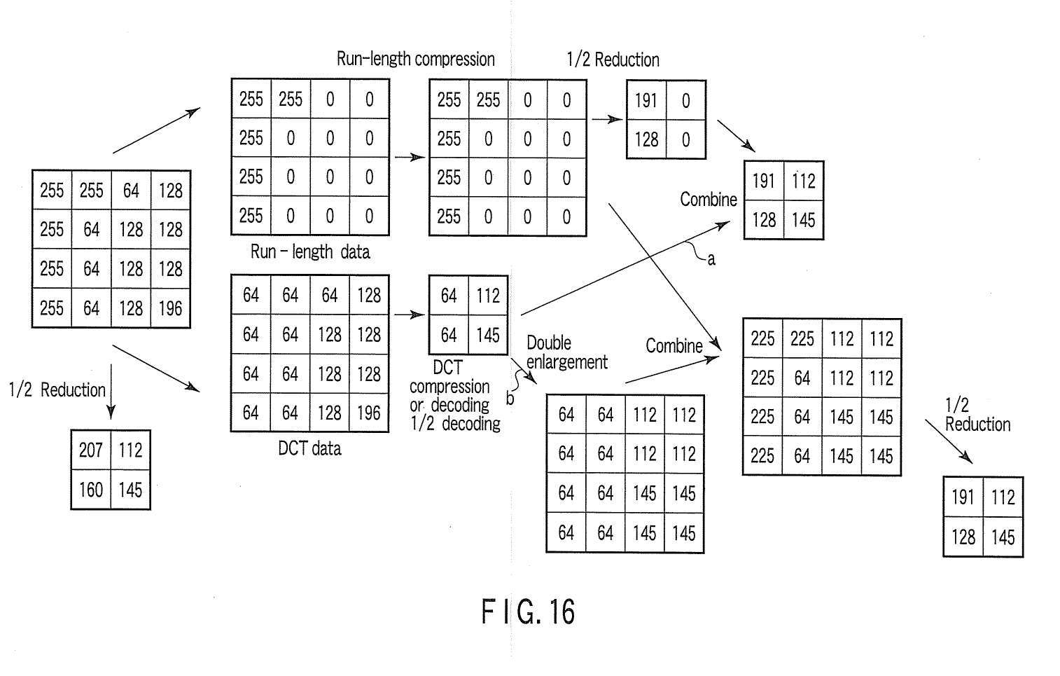

In the case of a DCT-only or run-length-only code, the result is outputted as reduction data. In the case of a code in which both exist, the results of both can be combined. The explanation of this is shown in FIG. 16. In FIG. 16, the explanation starts with compression processing.

Now, to simplify the explanation, a block is assumed to be a 4×4 unit. On the assumption that the value of 255 is represents a character, the value of 255 is separated from the other values to create run-length compression image data. A DCT image is created by filling the parts of the value 255 with the neighboring pixel values.

If there is no deterioration in image quality now, in ½ reduction decoding, an average value of a 2×2-pixel unit is outputted for DCT, and for run-length, run-length data is decoded in a 4×4 size. As the result of the run-length decoding is reduced and the area having the pixel value 0 is overwritten with the result of DCT, a reduced decoded image can be provided.

FIG. 16 shows the process of separating coefficients for DCT processing and coefficients for run-length compression processing from an image data block and then processing each coefficient.

Processing a of FIG. 16 is the operation shown in FIG. 13. However, a configuration in which the result of DCT reduction is enlarged by double and overwrites the result of run-length can also be employed, as in processing b of FIG. 16.

Also, in general, in the case where coding is carried out by a combination of the frequency code system and the non-frequency code system, high-frequency components such as shape are allocated to the non-frequency code system, not only in this embodiment but in many other cases. Therefore, by constantly decoding codes of the non-frequency code system and using them for decoding, it is possible to provide a reduced decoded image with high image quality.

In short, in a block code in which both the frequency conversion system and the non-frequency conversion system exist, a decoding resolution component of the frequency conversion system is arbitrarily selected. Here, in the processing to arbitrarily select and decode compressed data of the non-frequency conversion system, the compressed data of the non-frequency conversion system is decoded irrespective of the resolution of the decoded image.

Thus, with respect to compressed data in which codes of the frequency conversion system and the non-frequency conversion system are mixed or switched, the code of the non-frequency conversion system is decoded which generally has a smaller quantity of arithmetic operation than the frequency conversion system and has a larger volume of detailed information. Therefore, the balance between image quality and decoding speed is improved.

Naturally, to realize a higher speed, the mixed code can employ a configuration in which the run-length code is not decoded at the time of reduction decoding, or a configuration in which whether or not to decode the run-length code is set in accordance with the reduction ratio. In the case of a decoded image smaller than a block unit (in this example, less than ⅛), a reduced decoded image with sufficiently high image quality can be provided even when only the DC component of the frequency code system is used.

That is, when the decoding resolution is lower than the lowest resolution of the compressed data of the frequency conversion system, the lowest-resolution component (n=0) of the compressed data of the frequency conversion system is selected.

Thus, with respect to compressed data in which codes of the frequency conversion system and the non-frequency conversion system are mixed or switched, only the lowest-resolution component is used for decoding when the decoding resolution is lower than the lowest resolution component of the frequency conversion system. Therefore, the balance between image quality and decoding speed is improved.

Moreover, as mentioned in the first embodiment, when the reduction ratio is not ½n as in Patent Reference 1, for example, ⅙, a decoded image can be configured by a combination of enlargement of ⅛ OCT decoding to ⅙ and a ⅙ reduced image of the result of run-length.

In this embodiment, three patterns are described as examples, that is, a block unit containing a mixture of a frequency code and a non-frequency code, a block of frequency codes only, and a block of non-frequency codes only. However, the invention can be realized in a code format in which only the mixture exists (for example, only to combine in the processing of S2-10) or a code format in which only frequency codes or non-frequency codes exist (for example, only to select in S2-10). The format of frequency coding, and decoding procedures are not limited to this embodiment.

As a matter of course, it is obvious that a configuration with plural components such as YCbCr or CMYK as described in the first embodiment, and a configuration including a known identification signal other than an image can be provided.

As described above, with respect to a code in which both the frequency code system and the non-frequency code system exist, a reduced image with high image quality can be provided at a high speed.

What is claimed is:

1. An image decoding method in which compressed data of an image signal including plural components including a resolution component expressed by the n-th power of 2 (where n is an integer equal to or greater than 0) and processed by a frequency conversion system is decoded by inverse frequency conversion of each component, the method comprising
individually selecting and decoding a resolution component of each compressed data for each component when decoding resolution at the time of decoding is lower than the highest resolution of the compressed data.

2. The image decoding method according to claim 1, further comprising, when the decoding resolution is lower than the lowest resolution of compressed data as a decoding target, selecting and setting a lowest-resolution component (n=0) of this compressed data.

3. The image decoding method according to claim 2, further comprising, when the decoding resolution is higher than the lowest resolution of compressed data as a decoding target and lower than the highest resolution of the compressed data,
selecting a resolution component that is closest to the decoding resolution and equal to or higher than the decoding resolution, as a lowest-resolution component of the compressed data, and wherein each component has equal or different lowest resolution.

4. An image decoding method in which a compressed image formed by compressing an image signal including CMYK signals by using a frequency conversion system including a resolution component of the n-th power of 2 (where n is an integer equal to or greater than 0) is decoded by inverse frequency conversion of each color signal, the method comprising
selecting a resolution component of compressed data as a decoding target for each color signal when decoding resolution is lower than the highest resolution of the compressed data, and
selecting and decoding a lowest-resolution component (n=0) of the compressed data when the decoding resolution is lower than the lowest resolution of the compressed data, and selecting and decoding a resolution component that is closest to the decoding resolution and equal to or higher than the decoding resolution at least for the K signal when the decoding resolution is higher than the lowest resolution of the compressed data and lower than the highest resolution of the compressed data.

5. An image decoding method in which a compressed image formed by compressing an image signal of a block unit by mixing or switching a frequency conversion system and a non-frequency conversion system including a resolution component of the n-th power of 2 (where n is an integer equal to or greater than 0) is decoded, the method comprising
arbitrarily selecting and decoding a decoding resolution component of the frequency conversion system and compressed data of the non-frequency conversion system, for a block code in which both the frequency conversion system and the non-frequency conversion system exist.

6. The image decoding method according to claim 5, wherein in processing to arbitrarily select and decode the compressed data of the non-frequency conversion system,
the compressed data of the non-frequency conversion system is decoded irrespective of resolution of the decoded image.

7. The image decoding method according to claim 5, wherein the decoding resolution is lower than the lowest resolution of the compressed data of the frequency conversion system, a lowest-resolution component (n=0) of the compressed data of the frequency conversion system is selected.

8. An image decoding apparatus in which compressed data of an image signal including plural components including a resolution component expressed by the n-th power of 2 (where n is an integer equal to or greater than 0) and processed by a frequency conversion system is decoded by inverse frequency conversion of each component, the apparatus comprising:
a DCT coefficient take-out block that individually sets a resolution component of each compressed data for each component when decoding resolution at the time of decoding is lower than the highest resolution of the compressed data;
an inverse quantization block that inversely quantizes an output of the DCT coefficient take-out block; and
an inverse DCT block that performs inverse DCT processing to an output of the inverse quantization block.
